(19) United States
(12) Patent Application Publication
(10) Pub. No.: US 2022/0402621 A1
(43) Pub. Date: Dec. 22, 2022

(54) POWER DISTRIBUTION CONTROL SYSTEM AND METHOD FOR AIRCRAFT

(71) Applicant: Happy Takeoff, Inc., Coppell, TX (US)

(72) Inventor: Danielle McLean, Coppell, TX (US)

(21) Appl. No.: 17/842,035

(22) Filed: Jun. 16, 2022

Related U.S. Application Data
(60) Provisional application No. 63/211,405, filed on Jun. 16, 2021.

(51) Int. Cl. B64D 27/24

(52) U.S. Cl. CPC B64D 27/24; B64D 2221/00; B64D 2027/026

(57) ABSTRACT

A power distribution controller for a hybrid aircraft is configured to continuously: obtain a state-of-charge (SoC) measurement for a battery of the hybrid aircraft; obtain a fuel level measurement for a secondary energy source of the hybrid aircraft; receive a control input indicating one of a throttle level or an operating mode for one or more motors of the hybrid aircraft; calculate a ratio of energy to source from each of the battery and the secondary energy source in order to operate the one or more motors of the hybrid aircraft based on the control input, the SoC measurement, and the fuel level measurement; and transmit a control signal that causes energy to be apportioned from the battery and the secondary energy source to the one or more motors based on the determined ratio.

### CROSS-REFERENCE TO RELATED APPLICATIONS

This application claims the benefit of, and priority to, U.S. Provisional Patent Application No. 63/211,405, filed Jun. 16, 2021, which is incorporated herein by reference in its entirety.

### TECHNICAL FIELD

The present disclosure relates generally to hybrid aircraft, and more specifically to a power distribution and control system for hybrid aircraft.

### BACKGROUND

As battery and hybrid technology improves, there exists an ever-increasing demand to create cost-effective solutions for powering vehicles using these technologies. Not only are battery powered and hybrid vehicles potentially more efficient than internal combustion engine (ICE) vehicles, but battery and hybrid powertrains often produce fewer harmful emissions and, in some cases, can be more reliable than ICE powertrains. It would also be desirable to convert existing ICE powered vehicles to battery and/or hybrid system to potentially reduce costs (e.g., by not producing completely new vehicles), improve efficiency, and extend the operational lifespan of said vehicles.

Aircraft, such as helicopters and planes, may be of particular interest for conversion to battery and/or hybrid power. However, battery-only powertrains pose a number of problems in aviation. For example, the large battery packs required to provide energy for take-off and sustained flight of an aircraft often approach or exceed the weight restrictions for flight. Additionally, batteries can require long charging times and may take up significant space onboard an aircraft. Thus, few aircraft have been completely electrified due to the constraints of battery power. It would be beneficial to implement a hybrid system that makes use of the advantages of battery power, such as high power density for achieving take-off, and that utilizes another alternative energy source, such as a hydrogen fuel cell, to provide energy for sustained flight.

### SUMMARY

One implementation of the present disclosure is a power distribution controller for a hybrid aircraft. The controller includes one or more processors and memory having instructions stored thereon that, when executed by the one or more processors, cause the controller to continuously obtain a state-of-charge (SoC) measurement for a battery of the hybrid aircraft; obtain a fuel level measurement for a secondary energy source of the hybrid aircraft; receive a control input indicating one of a throttle level or an operating mode for one or more motors of the hybrid aircraft; calculate a ratio of energy to source from each of the battery and the secondary energy source in order to operate the one or more motors of the hybrid aircraft based on the control input, the SoC measurement, and the fuel level measurement; and transmit a control signal that causes energy to be apportioned from the battery and the secondary energy source to the one or more motors based on the determined ratio.

In some embodiments, the instructions cause the controller to further determine an operating mode for the hybrid aircraft based on the control input. In some embodiments, the operating mode is one of a take-off mode, a landing mode, or a cruising mode. In the take-off mode or the landing mode, more than 50% of the energy to operate the one or more motors of the hybrid aircraft is sourced from the battery. In the cruising mode, more than 50% of the energy to operate the one or more motors of the hybrid aircraft is sourced from the secondary energy source.

In some embodiments, if the ratio indicates that a greater portion of energy is sourced from the secondary energy source than the battery, the controller is further configured to transmit a second control signal that causes the second energy source to recharge the battery.

In some embodiments, the secondary power source is a hydrogen fuel cell.

In some embodiments, the one or more motors are electric motors.

In some embodiments, the hybrid aircraft is a helicopter, a vertical take-off and landing (VTOL) aircraft, or an electrical vertical take-off and landing (eVTOL) aircraft.

In some embodiments, the fuel level measurement includes a measurement of a fill level of each of an oxygen tank and a hydrogen tank.

In some embodiments, the instructions cause the controller to further calculate an amount of electrical energy that can be provided by the secondary power source based on the fill level of each of the oxygen tank and the hydrogen tank.

In some embodiments, the instructions cause the controller to receive additional data from at least one of an altitude sensor, an air speed sensor, or sensors that measure a rotational speed of each of the one or more motors of the hybrid aircraft and adjust the ratio based on the additional data.

In some embodiments, the instructions cause the controller to generate a graphical user interface that indicates, in real-time, the SoC measurement, the fuel level measurement, and the ratio.

Another implementation of the present disclosure is a method for distributing power to electric motors on a hybrid aircraft. The method includes obtaining a state-of-charge (SoC) measurement for a battery of the hybrid aircraft; obtaining a fuel level measurement for a secondary power source of the hybrid aircraft; receiving a control input indicating one of a throttle level or an operating mode for the electric motors of the hybrid aircraft; calculating a ratio of energy to source from each of the battery and the secondary power source in order to operate the electric motors of the hybrid aircraft based on the control input, the SoC measurement, and the fuel level measurement; and transmitting a control signal that causes energy to be apportioned from the battery and the secondary power source to the electric motors based on the determined ratio.

In some embodiments, the method further includes determining an operating mode for the hybrid aircraft based on the control input. In some embodiments, the operating mode is one of a take-off mode, a landing mode, or a cruising mode. In the take-off mode or the landing mode, more than 50% of the energy to operate the one or more motors of the hybrid aircraft is sourced from the battery. In the cruising mode, more than 50% of the energy to operate the one or more motors of the hybrid aircraft is sourced from the secondary energy source.

In some embodiments, the method further includes transmitting a second control signal that causes the second energy source to recharge the battery responsive to a determination that a greater portion of energy is sourced from the secondary energy source than the battery.

In some embodiments, the secondary power source is a hydrogen fuel cell.

In some embodiments, the hybrid aircraft is a helicopter, a vertical take-off and landing (VTOL) aircraft, or an electrical vertical take-off and landing (eVTOL) aircraft.

In some embodiments, the fuel level measurement includes a measurement of a fill level of each of an oxygen tank and a hydrogen tank.

In some embodiments, the method further includes calculating an amount of electrical energy that can be provided by the secondary power source based on the fill level of each of the oxygen tank and the hydrogen tank.

In some embodiments, the method further includes receiving additional data from at least one of an altitude sensor, an air speed sensor, or sensors that measure a rotational speed of each of the one or more motors of the hybrid aircraft; and adjusting the ratio based on the additional data.

In some embodiments, the method further includes generating a graphical user interface that indicates, in real-time, the SoC measurement, the fuel level measurement, and the ratio.

Yet another implementation of the present disclosure is a system for apportioning energy from multiple sources in a hybrid aircraft. The system includes a power control unit configured to determine a state-of-charge (SoC) measurement for a battery of the hybrid aircraft and a fuel level measurement for a hydrogen fuel cell of the hybrid aircraft; receive a control input indicating one of a throttle level or an operating mode for one or more motors of the hybrid aircraft; and calculate a ratio of energy to source from each of the battery and the secondary energy source in order to operate the one or more motors of the hybrid aircraft based on the control input, the SoC measurement, and the fuel level measurement. The system also includes a power distribution center in communication with the power control unit and configured to apportion energy from the battery and the secondary energy source to the one or more motors based on the ratio determined by the power control unit.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE FIGURES

Various objects, aspects, features, and advantages of the disclosure will become more apparent and better understood by referring to the detailed description taken in conjunction with the accompanying figures, in which like reference characters identify corresponding elements throughout. In the figures, like reference numbers generally indicate identical, functionally similar, and/or structurally similar elements.

FIG. 1 is a block diagram of a hybrid aircraft control system, according to some embodiments.

FIG. 2 is a block diagram of the hybrid aircraft control system of FIG. 1 in an alternate configuration, according to some embodiments.

FIG. 3 is a detailed block diagram of a power control unit used in the hybrid aircraft control system of FIGS. 1 and 2, according to some embodiments.

FIG. 4 is a flow diagram of a process for apportioning energy from multiple sources to drive the electric motor(s) of a hybrid aircraft, according to some embodiments.

FIG. 5 is a flow diagram of an alternate process for apportioning energy from multiple sources to drive the electric motor(s) of a hybrid aircraft, according to some embodiments.

FIG. 6 is a flow diagram of a process for apportioning energy from multiple sources during take-off for a hybrid aircraft, according to some embodiments.

FIG. 7 is a flow diagram of a process for apportioning energy from multiple sources when a hybrid aircraft is in a cruising operating mode, according to some embodiments.

FIG. 8 is an example user interface for a hybrid aircraft, according to some embodiments.

### DETAILED DESCRIPTION

Referring generally to the FIGURES, systems and methods for controlling the distribution of power from multiple energy sources to a motor or motors of an aircraft (e.g., a helicopter, an airplane, a drone, etc.) are shown, according to various embodiments. As briefly described above, batteries tend to have a greater power density (i.e., a higher specific power) than many other energy sources such as hydrogen fuel cells (HFCs), and can accordingly provide the energy required for take-off and landing. However, batteries are often heavy and may not be ideal for providing sustained flight. HFCs have a greater energy density (i.e., a higher specific energy) than batteries, and can accordingly provide energy for sustained operations such as cruising. Additionally, HFCs reduce the number of batteries or battery cells needed to power an aircraft through all stages of flight (e.g., take-off, cruise, landing), thus lowering the weight of the aircraft and extending available flight time/distance.

The control system described herein can apportion electrical energy from both batteries and HFCs to meet the requirements for each stage of flight. In particular, the control system may interpret sensor data and/or control inputs, such as from a user input device (e.g., a joystick, a throttle control, one or more buttons, switches, etc.), to determine which energy source to draw energy from (e.g., to power one or more electric motors) or to determine an amount of energy to draw from each source. For example, during take-off, the control system may provide 100% or nearly 100% of the energy for powering one or more electric motors from a battery pack. During cruise, the control system may provide 100% or nearly 100% of the energy for powering the one or more electric motors from a HFC stack, or may determine a ratio of energy to provide from each source. Advantageously, the control system may be retrofitted, along with the corresponding battery and HFC hardware, to existing ICE powered aircraft to provide a more modern and efficient powertrain. For example, helicopters may require a complete ICE engine replacement or overhaul every 12-15 years. Thus, the control system described herein may be used to replace the ICE engine with a hybrid powertrain, extending the helicopter's operating life. Additionally, the control system and hybrid powertrain described herein may require significantly less maintenance than a traditional ICE powertrain, further lowering operating costs.

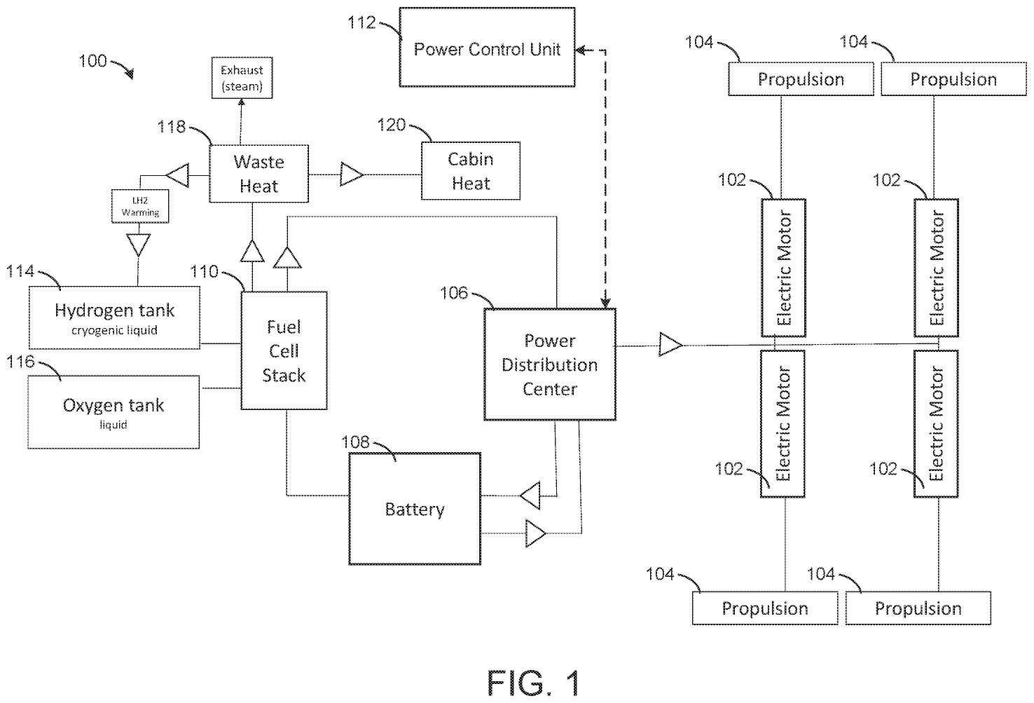

Turning first to FIG. 1, a block diagram of a hybrid aircraft system 100 is shown, according to some embodiments. As described above, system 100 may be included in or retrofitted to any suitable aircraft including, but not limited to, airplanes, helicopters, and drones, thereby converting these aircraft to a hybrid powertrain that is often cleaner, more efficient, and less expensive to maintain than traditional ICE powertrains. In some embodiments, such as in the configuration of FIG. 1, the system 100 is implemented in a vertical take-off and landing (VTOL) or electrical vertical take-off and landing (eVTOL) aircraft. Accordingly, the system 100 is shown to include a plurality of electric motors 102 that drive a plurality of propulsion devices 104, such as rotors, propellers, wheels, etc. In a VTOL configuration, for example, each of propulsion devices 104 may be positioned at a corner of the aircraft and may be selectively rotatable to provide upward, forward, and/or backward thrust. However, it will be appreciated that the system 100 may include any number and/or configuration of propulsion devices 104. For example, one or more of propulsion devices 104 could be positioned alongside wings of the aircraft to take advantage of distributed electric propulsion. In some embodiments, electric motors 102 may be coupled either directly to corresponding propulsion devices 104, or may be coupled through a gear or gear set for increasing or decreasing the rotational speed of an output of electric motors 102.

Multiple electric motors 102 are included in the system 100. In other embodiments, only one electric motor 102 is utilized such that the apportionment of energy may be via to that single electric motor, at least in part. Each of electric motors 102 can receive energy (e.g., electrical energy) from a power distribution center (PDC) 106, which may be configured to control the flow of energy from multiple energy sources to electric motors 102. In particular, PDC 106 may receive energy from a battery 108 and a fuel cell stack 110 and can apportion the available energy from each source to each of electric motors 102. PDC 106 may include any suitable components for achieving the apportionment of energy, including but not limited to electronic switches (e.g., relays, transistors, etc.), current limiting devices (e.g., resistors, potentiometers, etc.), capacitors, inductors, and the like. In some embodiments, PDC 106 includes a processor, memory, and/or a communications interface for receiving and transmitting data from/to a power control unit (PCU) 112, as described in greater detail below. In such embodiments, PDC 106 may receive control decisions regarding the apportionment of energy from battery 108 and fuel cell stack 110 and may subsequently control the apportionment of energy to one or more of the electric motors 102. For example, PDC 106 may selectively switch electronic switches (e.g., turning on/off transistors, switching relays, etc.), control current limiting devices (e.g., increase or decrease a resistivity of a potentiometer), or perform any other control actions for limiting or controlling the flow of energy from battery 108 and fuel cell stack 110 to one or more of the electric motors 102.

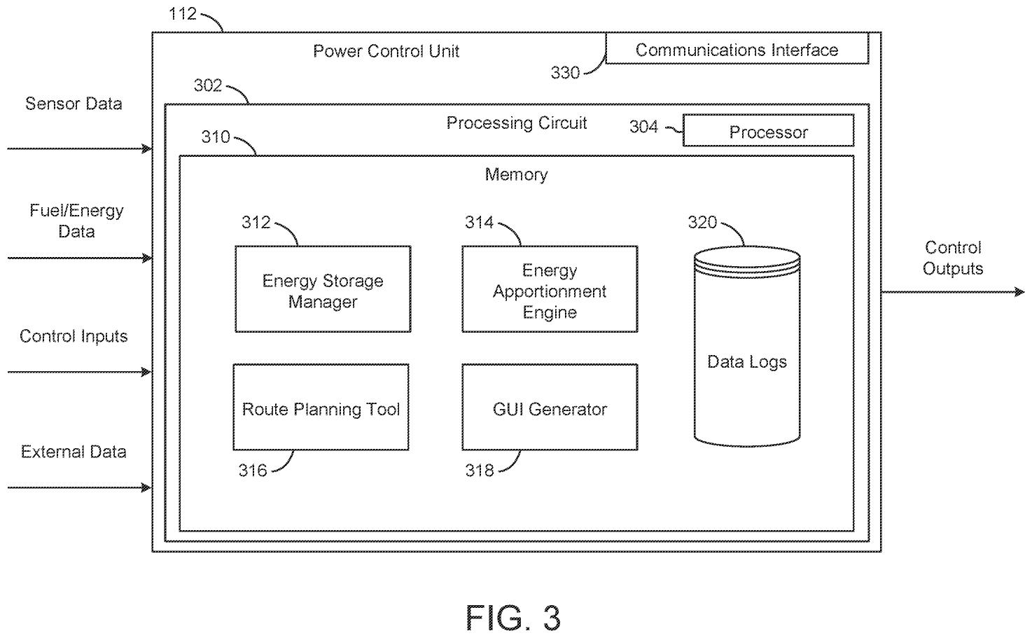

PCU 112 may also include one or more processors, memory, and/or a communications interface to communicate with PDC 106, as well as other components and systems of the aircraft (not shown). PCU 112 may be configured to receive sensor data from electric motors 102 and other aircraft components (e.g., altitude measurements, wind speed measurements, location data, temperature data, etc.), along with control inputs from user input devices (e.g., a throttle or joystick), to determine control decisions regarding the apportionment of energy from battery 108 and fuel cell stack 110. For example, PCU 112 may be configured to determine a percentage of total electrical energy to source from each of battery 108 and fuel cell stack 110, and PCU 112 may be configured to output control decisions (i.e., commands) to PDC 106 to cause PDC 106 to apportion energy accordingly. Additional features and advantages of PCU 112 are described in greater detail below with respect to FIG. 3.

Battery 108, as described herein, may include any number of battery cells for storing and supplying electrical energy. In some embodiments, battery 108 includes a plurality of battery cells or a plurality of batteries coupled in a series or parallel configuration to provide an amount of energy/power required to operate an aircraft. Battery 108 may also be formed from any suitable type of material and, as such, have a variety of configurations. For example, battery 108 may be lithium-ion, nickel-metal hydride, lead-acid, etc. In some embodiments, battery 108 can include ultracapacitors rather than traditional battery cells, or in addition to traditional battery cells, for storing and providing energy. For example, battery 108 may be constructed of a primary battery (e.g., lithium-ion) and a secondary battery (e.g., ultracapacitors). It will be appreciated that any suitable construction of battery 108 is contemplated herein. In some embodiments, battery 108 is sized based on the requirements of electric motors 102. For example, battery 108 may be designed to provide a specific voltage or current based on the requirements of electric motors 102, and may be sized based on other operational requirements (e.g., flight time, aircraft weight, etc.). Multiple batteries may be included with the system 100 where all of the batteries are of the same type or, in another embodiment, where at least one of the batteries differs in type or size from at least one other battery (e.g., a primary battery and a second battery).

Fuel cell stack 110 may include one or more fuel cells for converting chemical energy from hydrogen stored in a hydrogen tank 114 and oxygen stored in an oxygen tank 116 into electrical energy through reduction—oxidation (redox) reactions. Accordingly, fuel cell stack 110 may include any suitable types of fuel cells, such as proton-exchange membrane fuel cells (PEMFCs), phosphoric acid fuel cells (PAFCs), solid acid fuel cells (SAFCs), and the like. In general, fuel cell stack 110 is configured to provide an adequate amount of electrical energy to power electric motors 102; thus, fuel cell stack 110 may be sized (e.g., by number of fuel cells) to meet one or both of a voltage and/or operating current requirement of electric motors 102. In some embodiments, fuel cell stack 110 is sized to match the voltage and/or current output of battery 108. In this manner, PDC 106 can avoid having to step-down or step-up the voltage or current provided by fuel cell stack 110 and/or battery 108, which may result in undesirable losses.

It will be appreciated that, as described herein, hydrogen tank 114 may store hydrogen in any available form, such as a compressed gas, a liquid, a cryogenic liquid, etc. Likewise, oxygen tank 116 may store oxygen as a compress gas, a liquid, etc. It may be desirable, in some cases, to store both hydrogen and oxygen in a liquid form, to increase the amount of each element that can be stored and carried by the aircraft. Hydrogen tank 114 and/or oxygen tank 116 may be coupled to fuel cell stack 110 to provide hydrogen and oxygen for producing electricity. In some embodiments, the coupling between hydrogen tank 114/oxygen tank 116 and fuel cell stack 110 includes piping or conduit and one or more valves (e.g., electronically controlled valves) or other similar devices for controlling the flow of each element into fuel cell stack 110. In other embodiments, fuel cell stack 110 may control the flow of each element, such as based on an amount of electricity to be generated.

In some embodiments, system 100 is configured to extract oxygen from the atmosphere to fill/refill oxygen tank 116. In embodiments where oxygen tank 116 is configured to hold oxygen in a liquid or compressed gas form, the system 100 may include suitable components for liquefying or compressing the extracted oxygen. For example, the system 100 may include pumps or a cooling system for converting the oxygen extracted from the atmosphere to a suitable state for storage. Likewise, the system 100 may include components for extracting the oxygen from air, such as a cryogenic distillation system or a vacuum swing absorption system. Any of these additional system for extracting or storing oxygen may be powered at least in part by battery 108 and/or fuel cell stack 110. However, at high altitudes (e.g., over 10,000 feet), it may not be viable or energy efficient to extract oxygen from the atmosphere (e.g., due to the low density of oxygen at these higher altitudes). Accordingly, sensor data may be utilized to determine the aircraft's altitude and adjust oxygen extraction. For example, oxygen extraction may be ceased above certain altitudes.

Along similar lines, in some embodiments, the system 100 is configured to produce and store hydrogen (e.g., in hydrogen tank 114) in flight, or while the aircraft (e.g., and thereby system 100) is otherwise operating. For example, system 100 may further include a water tank (not shown) or other vessel for holding water and, in some embodiments, may extract hydrogen from the on-board water supply. In some embodiments, hydrogen may be extracted from water that is collected from the air (e.g., external and/or internal to the aircraft). In some embodiments, hydrogen can be extracted from wastewater aboard the aircraft, such as wastewater collected from a sink, a toilet, etc. Accordingly, in some such embodiments, system 100 may be configured to perform any suitable technique for extracting hydrogen from water, such as electrolysis or water splitting.

In some embodiments, waste heat 118 may be produced as a byproduct of electricity generation from fuel cell stack 110. Advantageously, the system 100, via control from the PCU 112, may utilize at least a portion of waste heat 118 to provide cabin heat 120, for heating a cabin of the aircraft. In some embodiments, a portion of waste heat 118 is used to heat the cryogenic liquid hydrogen stored in hydrogen tank 114. As shown, for example, waste heat 118 may be provided to a liquid hydrogen warming subsystem for heating hydrogen tank 114. Any waste heat 118 that is not utilized for cabin heat 120 or hydrogen warming may be expelled from the aircraft in the form of exhaust. However, unlike many ICE powered aircraft, the exhaust from control system 100 is primarily steam due to the combination of hydrogen and oxygen in the fuel cell.

Still referring to FIG. 1, in some embodiments, PDC 106 is configured to provide energy to (i.e., recharge) battery 108. In such embodiments, PDC 106 may apportion part of the energy provided by fuel cell stack 110 to battery 108. For example, fuel cell stack 110 may provide a majority of the energy required for sustained flight, such as during cruising; thus, battery 108 may be recharged when not in use (e.g., during cruising) with a portion of this electrical energy. In some embodiments, battery 108 may be recharged directly from fuel cell stack 110. In some embodiments, battery 108 includes an internal battery management system (BMS) for controlling and monitoring the charging/discharging of battery 108, and for balancing the charge of each individual battery cell. In other embodiments, PDC 106 may include a BMS or the BMS may be a separate component from PDC 106 and battery 108.

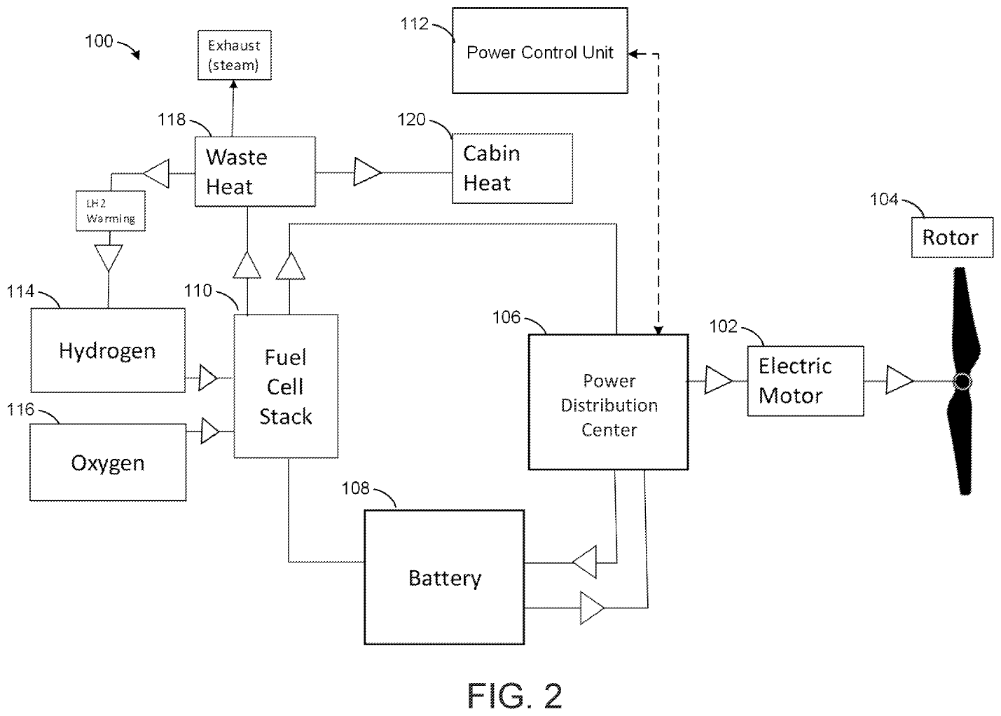

Referring now to FIG. 2, the system 100 is shown in an alternate configuration, according to some embodiments. In particular, the configuration of FIG. 2 may be a system for a helicopter or other aircraft that includes only one electric motor 102 and propulsion device 104, shown as a rotor in this example. Thus, the configuration of the system 100 shown in FIG. 2 may operate similarly to the configuration described above with respect to FIG. 1, with the exception that PDC 106 apportions energy from battery 108 and fuel cell stack 110 to only one electric motor 102.

Referring now to FIG. 3, a detailed block diagram of PCU 112 is shown, according to some embodiments. As described above, PCU 112 may be configured to receive data from the various components and subsystems of control system 100 in order to generate control outputs that affect how PDC 106 apportions energy from battery 108 and/or fuel cell stack 110. In this manner, PCU 112 may control the apportionment of energy to provide for a hybrid powertrain (e.g., control system 100) for use in aircraft that overcomes the disadvantages of battery-only or ICE powertrains described above. As described herein, PCU 112 may be an individual component of the system 100, or various portions or functionalities of PCU 112 may be implemented/performed by any of the other components of the system 100 described above. It will be appreciated that all such configurations of PCU 112 and control system 100 are described herein.

In one embodiment, the PCU 112 is included with the PDC as a controller for the PDC. In another embodiment, the PCU 112 is a separate component relative to the PDC 106 whereby the PCU 112 is communicative coupled to the PDC 106, among other components. As alluded to above, the PCU 112 may be a single electronic control unit (ECU) (e.g., controller or microcontroller) or multiple ECUs. In one embodiment, the components of the PCU 112 are combined into a single unit like as shown. In another embodiment, one or more of the components may be geographically dispersed throughout the system or aircraft. In this regard, various components of the PCU 112, discussed below, may be dispersed in separate physical locations of the system 100

PCU 112 is shown to include a processing circuit 302 that includes a processor 304 and memory 310. Processor 304 may be a general purpose or specific purpose processor, an application specific integrated circuit (ASIC), one or more field programmable gate arrays (FPGAs), a group of processing components, or other suitable processing components. Processor 304 may be configured to execute computer code or instructions stored in memory 310 or received from other computer readable media (e.g., CDROM, network storage, a remote server, etc.).

Memory 310 may include one or more devices (e.g., memory units, memory devices, storage devices, etc.) for storing data and/or computer code for completing and/or facilitating the various processes described in the present disclosure. Memory 310 may include random access memory (RAM), read-only memory (ROM), hard drive storage, temporary storage, non-volatile memory, flash memory, optical memory, or any other suitable memory for storing software objects and/or computer instructions. Memory 310 may include database components, object code components, script components, or any other type of information structure for supporting the various activities and information structures described in the present disclosure. Memory 310 may be communicably connected to processor 304 via processing circuit 302 and may include computer code for executing (e.g., by processor 304) one or more processes described herein.

Memory 310 is shown to include an energy storage manager 312 configured to determine and manage an amount of energy stored in battery 108 and/or an available capacity of fuel cell stack 110. In some embodiments, energy storage manager 312 receives charge level data from battery 108 (e.g., via a communications interface 330) indicating a state-of-charge (SoC) of battery 108, which may be represented as a percentage of total capacity. (e.g., 80%). For example, battery 108 may include a B MS (e.g., internally or externally) that determines the battery's SoC by measuring the current and/or voltage of the battery, and that subsequently reports the SoC reading to energy storage manager 312. In other embodiments, energy storage manager 312 determines a SoC of battery 108 based on measurements from other sensors or systems. For example, energy storage manager 312 may interpret a reading from a current and/or voltage detection circuit to determine the SoC of battery 108. It will be appreciated that any other method for determine the SoC of battery 108 is also contemplated herein.

In some embodiments, energy storage manager 312 is also configured to determine an available capacity of fuel cell stack 110. For example, energy storage manager 312 may receive sensor data from hydrogen tank 114 and/or oxygen tank 116 that indicates a fill level of the corresponding tank. Energy storage manager 312 may the calculate an amount of energy that fuel cell stack 110 can produce based on the remaining fuel in one or both of hydrogen tank 114 and oxygen tank 116. For example, energy storage manager 312 may determine energy requirements of one or more electric motors 102 based on known energy consumption rates (e.g., based on motor speed or load) and may subsequently determine a hydrogen and/or oxygen consumption rate, which can be used to determine an amount of energy that can be provided by fuel cell stack 110. It will be appreciated that any other method for determine the amount of energy that can be provided by fuel cell stack 110 is also contemplated herein.

Memory 310 is also shown to include an energy apportionment engine 314 configured to determine an amount of energy to source from each of battery 108 and fuel cell stack 110 in order to drive electric motors 102. In some embodiments, energy apportionment engine 314 receives sensor data (e.g., from any sensors of the aircraft) and/or control inputs to determine the apportionment of energy. For example, energy apportionment engine 314 may receive sensor data indicating a rotational speed (e.g., RPM), torque demand, current or expected power demand, etc. of electric motors 102, which may be used to determine energy apportionment. As described herein, energy apportionment may be expressed as a ratio of energy to source from battery 108 and/or fuel cell stack 110. For example, during take-off, a predefined amount of the total energy demand may be sourced from battery 108, which has a higher specific power than fuel cell stack 110, and any remainder of energy required for operation may be sourced from fuel cell stack 110. In one embodiment and as described herein, the predefined amount is approximately 90%-100% of the total energy demand being sourced from the battery. In another embodiment, a different predefined amount may be sourced from the battery for take-off. During cruising or a cruising mode of operation, a larger portion (e.g., greater than 10% and upwards of 50%) of the total energy demand required for flight during the cruising mode of operation may be sourced from fuel cell stack 110, which has a higher specific energy than battery 108.

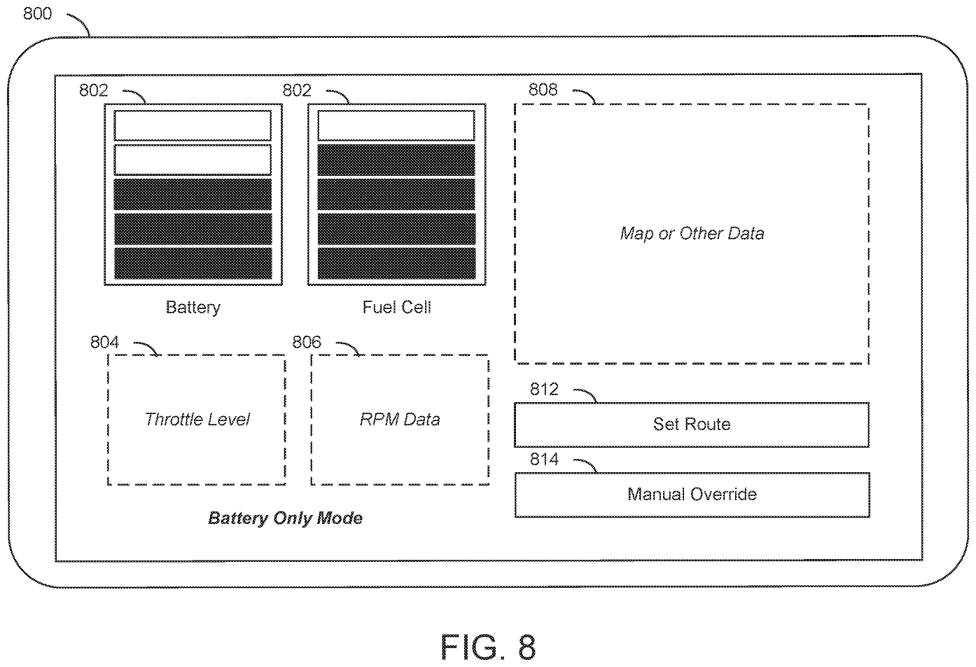

In addition to or in place of sensor data, energy apportionment engine 314 may determine energy requirements based on control inputs, such as from a user interface. A user interface may include a throttle control and/or a joystick, a touchscreen, a keypad or keyboard, or any other interface that allows a user to provide inputs and, in some cases, presents data for the user to view. In an aircraft, for example, the user interface can include a joystick and at least one display (e.g., a touchscreen display) for presenting flight related data. An example user interface is described below with respect to FIG. 8.

During operation, a user may provide an input to a user interface device (e.g., a joystick, touchscreen/control screen, etc.) and any control inputs may be received by PCU 112, and more specifically by energy apportionment engine 314, to determine energy apportionment. For example, an input to a joystick or throttle control may control a rotational speed of electric motors 102 (e.g., increasing throttle may increase motor speed to generate lift) and a commanded rotational speed of electric motors 102 can be used to determine energy apportionment. In particular, certain rotational speeds (e.g., expressed as RPMs) or an RPM range may be associated with take-off of the aircraft; thus, energy apportionment engine 314 may cause a larger portion of energy to be sourced from battery 108 in response. In contrast, lower RPMs may indicate that the aircraft is cruising or hovering, in which case energy apportionment engine 314 may reduce the amount of energy sourced from battery 108 in favor of energy from fuel cell stack 110. In this way, the PCU 112 may determine take-off automatically based on a rotational speed. In other embodiments, multiple or different inputs may be used to determine an entry or exit into and out of take-off and cruising operating modes (e.g., altitudes above a predefined amount combined with certain rotational speeds may indicate cruising operation, explicit inputs may indicate take-off or cruising, etc.).

In some embodiments, energy apportionment engine 314 can account for available energy from battery 108 and/or fuel cell stack 110 when determining the apportionment of energy, such as by receiving data from energy storage manager 312. For example, energy apportionment engine 314 may reduce an amount of energy sourced from battery 108 and increase an amount of energy sourced from fuel cell stack 110 responsive to determining that the SoC of battery 108 is low (e.g., below a threshold). Likewise, energy apportionment engine 314 may utilize more energy from battery 108 during cruising if it is determined that one or both of hydrogen tank 114 and oxygen tank 116 are running low.

In some embodiments, energy apportionment engine 314 can account for other sensor data in determining energy apportionment. In some such embodiments, energy apportionment engine 314 may interpret altitude readings to infer a mode of operation for the aircraft, which may affect energy apportionment. For example, an altitude reading of 2,000-3,000 feet may provide a good indication that a helicopter is cruising (e.g., versus taking off or landing); thus, energy apportionment engine 314 may source a greater amount of energy from fuel cell stack 110 over battery 108. In some embodiments, energy apportionment engine 314 accounts for air speed data when apportioning energy. In some embodiments, energy apportionment engine 314 accounts for data from external sources when determining the apportionment of energy. For example, an external weather service may provide weather related data that may affect the aircraft's flight (e.g., by altering a flight path, causing the aircraft to flight lower/higher, etc.), which can be utilized in the determination made by energy apportionment engine 314. It will be appreciated that any other sensor/remote data may be utilized by energy apportionment engine 314 to determine energy apportionment.

Still referring to FIG. 3, memory is also shown to include a route planning tool 316, which is configured to determine optimized flight paths and coordinates with energy apportionment engine 314 to determine energy apportionment along the flight paths. As described herein, an “optimized” flight path is a flight path that maximizes or attempts to maximize the efficiency of the aircraft, such as by using the least amount of fuel, taking the shortest amount of time, etc. (i.e., maximizes or minimizes a desired characteristic, such as minimizes fuel consumption). In particular, route planning tool 316 may be configured to calculate flight paths (i.e., routes) based on user inputs. For example, a user may input a destination (e.g., coordinates, an airport name, an address, etc.) and route planning tool 316 may determine an optimized flight path based on fuel/energy data. Accordingly, in some embodiments, route planning tool 316 may receive fuel/energy data (e.g., from sensors, battery 108, etc.) to determine a maximum flight duration, a maximum and/or ideal altitude, etc., to reach the destination without running out of energy, or that preserves the maximum amount of energy.

To generate a flight path, route planning tool 316 may determine parameters such as engine speed and energy source at one or more time steps of a time horizon (e.g., the flight time), or at one or more steps along the flight path. In other words, route planning tool 316 may plan an expected RPM for electric motors 102 and an apportionment of energy from battery 108 and/or fuel cell stack 110 at each time step along the path. For example, from time t=0 to t=1 minute, which may encompass take-off of the aircraft, route planning tool 316 may predict that 100% of the energy required for operation should be sourced from battery 108. Accordingly, route planning tool 316 may estimate a remaining SoC of battery 108 after take-off (e.g., from time t=1 minute and onward) and may plan a remainder of the route accordingly.

In some embodiments, route planning tool 316 utilizes external data when generating optimized flight routes. For example, route planning tool 316 may receive weather data from an external weather service or from a remote computing device to determine weather patterns and predictions along one or more flight paths. In this manner, route planning tool 316 may adjust routes to avoid inclement weather, for example. In some embodiments, route planning tool 316 may communicate with an external air traffic management system to ensure that a generated flight path does not conflict with the flight paths of other aircraft. For example, route planning tool 316 may cross-reference a generated flight path with known flight paths from the air traffic management system and, if a conflict is detected, may adjust the flight path and/or warn an operator of the aircraft. In some embodiments, route planning tool 316 can continuously communicate with the air traffic management system (e.g., while in the air) to avoid collisions while flying. The route planning tool 316 may communicate with the air traffic management system via a satellite link (e.g., Starlink®) or other suitable network.

In some embodiments, route planning tool 316 may continuously determine an amount of energy required to reach a destination, even when a user is manually controlling the aircraft. In some such embodiments, route planning tool 316 can be configured to determine that the aircraft will not reach a destination based on the remaining amount of energy, and may automatically limit certain aircraft operations (e.g., reducing maximum speed or altitude). Additionally, route planning tool 316 may identifying a closest airport or other location capable of refueling the hydrogen tank 114 and/or oxygen tank 116, or recharging battery 108, and may automatically guide the aircraft to the identified location. For example, PCU 112 may take over control from a user (e.g., if in manual mode) or alert the user that the aircraft will not reach a destination based on the remaining amount of energy. The route planning tool 316 may then suggest one or more intermediate destinations for the user, which the user can select to adjust the flight path for refueling or recharging. However, it will be appreciated that any of the autonomous and/or semi-autonomous features of route planning tool 316 described herein may be easily disabled by a user (e.g., via a user interface such as the user interface of FIG. 8).

In some cases, it may not be possible to reach a destination using the available fuel or energy stored by control system 100. In these instances, route planning tool 316 may plan stops for recharging and/or refueling that minimize flight time. For example, route planning tool 316 may use external data (e.g., an online map service) to identify airports or other locations that offer hydrogen and/or oxygen refueling, or that offer battery charging, and may plan for a stop at said location(s) along the flight path. In some embodiments, route planning tool 316 may plan a stop for the minimum amount of time to recharge/refuel before continuing to the destination, while ensuring that the aircraft retains a predefined amount of reserve energy (e.g., 10% battery) to account for unforeseen circumstances (e.g., inclement weather).

In some embodiments, route planning tool 316 utilizes a form of artificial intelligence (AI) to generate optimized flight paths based on available energy. In some such embodiments, route planning tool 316 can include predictive models (e.g., mathematical models, neural networks, or the like) that may be executed based on input parameters to generate a predicted flight path. For example, route planning tool 316 may include one or more neural networks that are executed by inputting operational data such as destination, flight time, estimated altitudes and speeds, weather data, air quality and pressure data, etc., to predict energy requirements at various points along the flight path (e.g., every second, every minute, every few feet, etc.). Such neural networks can include feedforward neural networks, recurrent neural networks (RNNs), perceptron's, convolutional neural networks (CNNs), deep neural networks, etc.

In some embodiments, route planning tool 316 is configured to learn energy requirements and usage parameters over time. For example, the AI or neural networks included in route planning tool 316 may be trained and/or improved based on flight data, such as while a user manually controls the aircraft. In this case, operational data may recorded for each flight of the aircraft, including motor RPM, battery usage, fuel cell usage, altitude, air speed, etc., and may be stored in data logs 320. These data logs 320 may be used to train and improve the predictions made by route planning tool 316. Accordingly, route planning tool 316 may continually improve/optimize planned routes, allowing PCU 112 to gradually take over flight controls from a user. In this manner, PCU 112 may allow for completely manual flight control (e.g., based solely on user inputs), semi-autonomous flight control (e.g., based on planned routes with some or little user input), and eventually completely autonomous flight (e.g., based on a destination).

Memory 310 is also shown to include a graphical user interface (GUI) generator 318 configured to generate graphical user interfaces for presenting flight-related information to a user. For example, GUI generator 318 may generate an interface for presenting fuel and/or energy levels, planned routes, current sensor reading (e.g., motor RPM), and any other relevant data. In some embodiments, the user interfaces may allow a user to set or adjust a planned flight path, and may allow a user to override control decisions. For example, a user may choose to override an apportionment of energy, as determined by energy apportionment engine 314. Additional features of GUI generator 318, and an example GUI generated by GUI generator 318, are described below with respect to FIG. 8.

Communications interface 330, as briefly mentioned above, may include wired or wireless interfaces (e.g., jacks, antennas, transmitters, receivers, transceivers, wire terminals, etc.) for conducting data communications with various systems, devices, or networks. In particular, communications interface 330 may be configured to transmit and receive data from/to PDC 106 (when the PCU 112 is embodied as a separate component relative to the PDC 106), and may also receive data from any other aircraft components (e.g., sensors, input devices, etc.). For example, communications interface 330 may a WiFi or Bluetooth® transceiver for communicating via a wireless communications network. In another example, communications interface 330 may connect to satellite network such as Starlink® for communicating via the Internet or other networks. In some embodiments, communications interface 330 may be configured to communicate via local area networks or wide area networks (e.g., the Internet, a WAN, a LAN, etc.) and may use a variety of communications protocols (e.g., IP, LON, etc.).

In some embodiments, communications interface 330 includes a cellular network or satellite connection for receiving data from remote sources (e.g., servers, the Internet, etc.) while the aircraft is in flight. In some embodiments, communications interface 330 is a node on a controller area network (CAN) bus that receives/transmit serial data communications from the other components of control system 100. For example, each of PDC 106 and PCU 112 may be nodes on a CAN bus for an aircraft, which don't require additional wiring or communications paths directly between PDC 106 and PCU 112. In some embodiments, battery 108 (e.g., a BMS) and/or fuel cell stack 110 may include CAN bus modules or controllers for communicating via a CAN bus.

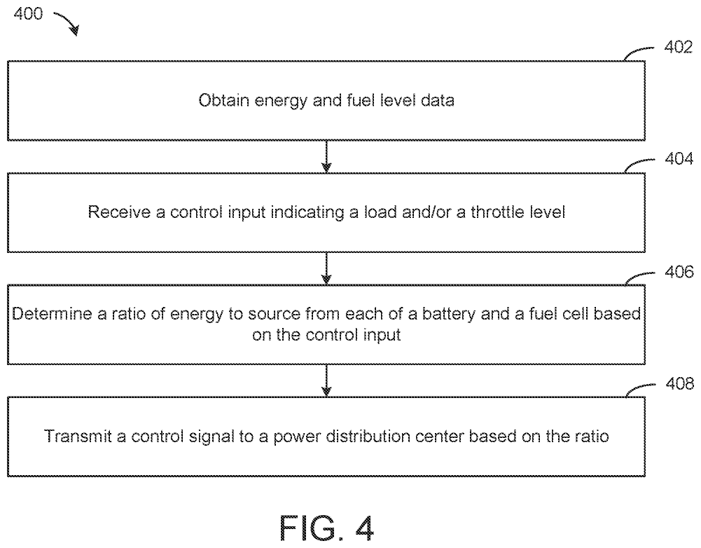

Referring now to FIG. 4, a flow diagram of a process 400 for apportioning energy from multiple sources (e.g., battery 108 and fuel cell stack 110) to drive electric motors 102 is shown, according to some embodiments. Process 400 may be implemented by PCU 112, for example; however, it will be appreciated that in some embodiments, process 400 is implemented by other components of system 100 or by other computing devices. It will also be appreciated that certain steps of process 400 may be optional and, in some embodiments, process 400 may be implemented using less than all of the steps. By implementing process 400, a computing device such as PCU 112 can control energy apportionment within a battery-hydrogen hybrid powertrain for an aircraft, which provides numerous advantages over battery-only or ICE powered powertrains as described above.

At step 402, energy and/or fuel level data is obtained by the PCU 112. In particular, energy data may be received for a battery (e.g., battery 108) that indicates, for example, a SoC for the battery or another indicator of an amount of battery energy available. In various embodiments, battery SoC information is received directly from the battery (e.g., from an internal BMS), indirectly from the battery (e.g., by measuring current and/or voltage provided by the battery), and/or from an external BMS. The SoC information may indicate, for example, a percentage of remaining battery life or an amount of energy remaining in the battery (e.g., in kWhs). Likewise, fuel level data may be obtained from sensor readings for hydrogen and oxygen fuel tanks, which indicates an amount of hydrogen and oxygen remaining (or, alternatively, available). In this regard, the fuel level data may be used to determine or predict an amount of electrical energy that can be provided by a hydrogen fuel cell stack. For example, the amount of hydrogen and oxygen stored in storage tanks and an estimated hydrogen/oxygen consumption rate, may be used to calculate an expected flight time, as described in greater detail below.

At step 404, a control input is received by the PCU 112 that includes a load requirement and/or throttle level. The load requirement and/or throttle level may be used to determine and/or predict a total amount of energy required from a battery and a fuel cell to operate the aircraft. In some embodiments, the control input is received form a user input device, such as a joystick or throttle control, and the control input is used to determine a corresponding motor speed (e.g., in RPM). For example, a 50% throttle level in a helicopter may cause a rotor to spin at 300 RPM, which may translate directly to motor speed (e.g., if connected directly) or which may be used to determine the motor speed (e.g., if connected through one or more gears). In some embodiments, certain control inputs may indicate an operational mode of the aircraft. For example, high throttle inputs (e.g., above 60%) may indicate that the aircraft is in a take-off mode, or that the aircraft is attempting to climb.

At step 406, a ratio of energy to source from each of the battery and the hydrogen fuel cell is determined by the PCU 112 based on the control input. In other words, energy is apportioned based on the control input. In some embodiments, energy is apportioned based on a required motor speed (e.g., in RPM) associated with the control input. In the example above, a 50% throttle level in a helicopter may cause a rotor to spin at 300 RPM; thus, energy apportionment may be determined to provide enough energy to spin the rotor and/or an electrical motor at 300 RPM. In this example, the 50% throttle level may indicate that the aircraft (e.g., a helicopter) is nearly a cruising mode of operational, and is thus reading the end of a take-off mode. Accordingly, a larger portion of energy may be sourced from the battery (e.g., 60%) versus the hydrogen fuel cell (e.g., 40%). The PCU 112 may be configured to determine, based on the control input, the ratio of energy from each source.

In some embodiments, a majority of the total energy required (e.g., more than approximately 50% and, preferably, more than approximately 90% or more) is sourced from the battery during take-off or at high motor RPMs. As described above, batteries generally have a higher specific power than hydrogen fuel cells, thereby more readily providing the energy necessary for take-off. In contrast, a majority of energy may be sourced from the hydrogen fuel cell when cruising (e.g., maintaining a constant speed/altitude), because hydrogen fuel cells typically have a higher specific energy than batteries. However, process 400 may advantageously determine a ratio of energy at any stage in between take-off, cruising, and landing. For example, there exists a time period between take-off and cruising when motor RPMs may not necessarily fit neatly into a “take-off” or “cruising” mode. In another example, the aircraft may be controlled to climb slowly, which may not be considered take-off but which may require more energy than cruising. In these and other cases, any suitable ratio of energy may be determined. In some embodiments, anywhere from 0-100% of the energy required for powering the electric motors to meet operational demands (e.g., RPM) may be sourced from one or both of the battery and the hydrogen fuel cell.

At step 408, a control signal may be transmitted by the PCU 112 to a power distribution center (e.g., PDC 106) based on the energy apportionment ratio. The control signal may cause the PDC to control the flow of energy from each of the battery and the hydrogen fuel cell. For example, the PDC may include any number of components (e.g., switches, resistive elements, etc.) for controlling current flow to the electric motors. In some embodiments, the PDC may provide energy from both the battery and the hydrogen fuel cell (e.g., where less than 100% energy is provided by one of the battery and the hydrogen fuel cell). In some embodiments, the PDC may provide 100% of the energy required from one of the battery and the hydrogen fuel cell. In some embodiments, the PDC may cause based on a command from the PCU 112 the fuel cell to recharge the battery if the battery is required to provide less than a predefined amount of energy (e.g., less than 100%, less than 50%, etc. of the energy). For example, while cruising, the aircraft may operate on a predefined amount (e.g., 100% or nearly 100%) of hydrogen fuel cell power, in which case a portion of the energy from the fuel cell may be used to recharge the batteries. In some embodiments, the PDC is also configured to control/adjust the voltage or current provided by the batteries and/or the fuel cell. For example, the PDC may increase or decrease a voltage of the batteries and/or the fuel cell to meet the requirements of the electric motors.

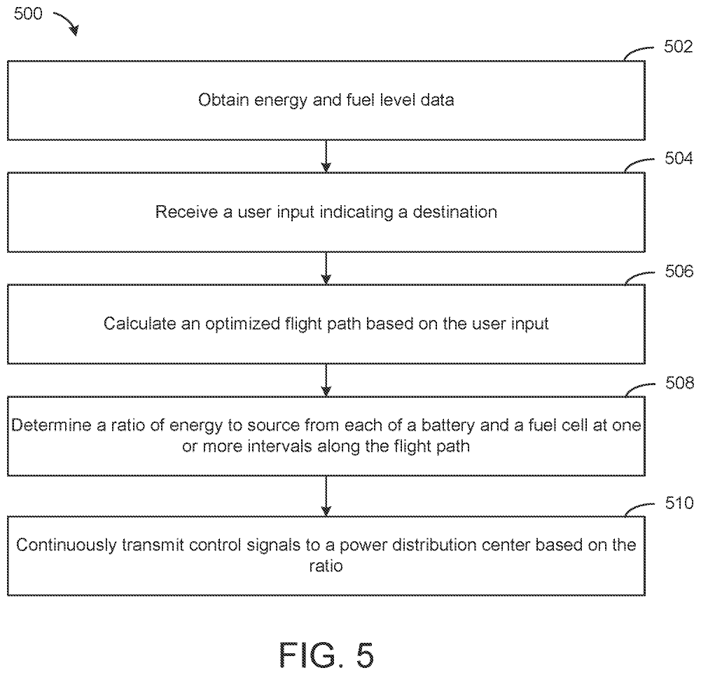

Referring now to FIG. 5, a flow diagram of an alternate process 500 for apportioning energy is shown, according to some embodiments. Process 500 may be implemented by PCU 112, for example; however, it will be appreciated that in some embodiments, process 500 is implemented by other components of control system 100 or by other computing devices. It will also be appreciated that certain steps of process 500 may be optional and, in some embodiments, process 500 may be implemented using less than all of the steps. Process 500 may advantageously allow for semi-autonomous or fully autonomous aircraft operations by automatically determining energy apportionment and controlling flight according to a generated flight path.

At step 502, energy and/or fuel level data is obtained. In this regard, step 502 may be the same as or similar to step 402, described above. For example, energy data may be received for a battery (e.g., battery 108) that indicates a SoC for the battery. In various embodiments, battery SoC information is received directly from the battery (e.g., from an internal BMS), indirectly from the battery (e.g., by measuring current and/or voltage provided by the battery), and/or from an external BMS. The SoC information may indicate, for example, a percentage of remaining battery life or an amount of energy remaining in the battery (e.g., in kWhs). Likewise, fuel level data may be obtained from sensor readings for hydrogen and oxygen fuel tanks, which indicates an amount of hydrogen and oxygen remaining. In this regard, the fuel level data may be used to determine or predict an amount of electrical energy that can be provided by a hydrogen fuel cell stack. For example, the amount of hydrogen and oxygen stored in storage tanks and an estimated hydrogen/oxygen consumption rate, may be used to calculate an expected flight time, as described in greater detail below.

At step 504, a user input is received that indicates a destination. The user input, for example, may include an address, geographical coordinates, or any other indication of a destination, such as an airport. In some embodiments, the user input may be received via a user interface, such as the user interface of FIG. 8 described below. In other embodiments, the user input may be received from an external sources (e.g., a remote computing device). For example, in fully autonomous operations, the user input may be received (e.g., by PCU 112) from a remote computing device operated by the user.

At step 506, an optimized flight path is calculated or determined based on the user input (e.g., by the PCU 112). The optimized flight path may indicate at least a direction, a speed, and an altitude for the aircraft to fly to reach the destination. In particular, at least a direction, a speed, and an altitude may be determined for each time step or other interval along the flight path. For example, the flight path may be sectioned into multiple time steps (e.g., based on an estimated flight time) or intervals (e.g., based on distance traveled), each with a unique heading, speed, altitude, etc. It will be appreciated that the flight path may be broken into any number of intervals, such as time based (e.g., every second), distance based (e.g., every few feet), a combination thereof, and so on. In any case, the flight path may be optimized to minimize energy consumption and/or travel time (or otherwise optimize a desired variable of interest). Accordingly, in some embodiments, the flight path may also be calculated or determined in part based on the energy and fuel levels obtained at step 502. For example, the flight path may be calculated to account for the battery's SoC or remaining hydrogen/oxygen fuel levels, to ensure that the aircraft arrives safely at a destination or an intermediate destination (e.g., a location for refueling or recharging). In some embodiments, the flight path calculation may account for a safety buffer that requires a certain amount of battery and/or available fuel cell energy (e.g., 10%) to be available upon arrival.

At step 508, a ratio of energy to source from each of the battery and the hydrogen fuel cell is determined by the PCU 112 for each interval of the flight path. In this regard, step 508 may be the same as or similar to step 406 described above; however, a unique ratio is calculated at each interval. Thus, step 508 may account for changes along the flight path without user input. For example, at a first set of intervals associated with take-off (e.g., each interval associated with a higher altitude than the last), a larger ratio of energy may be sourced from the battery, while at a second set of intervals associated with cruising (e.g., each interval has a relatively similar altitude to the last), more energy may be sourced from the hydrogen fuel cell.

At step 510, a control signal may be transmitted by the PCU 112 to a power distribution center (e.g., PDC 106) based on the energy apportionment ratio. Again, step 510 may be similar to or the same as step 408 described above, with the exception that control signals maybe continuously transmitted as the aircraft navigates along the flight path. For example, a control signal may be transmitted at each interval based on the time of flight or based on a location of the aircraft. Accordingly, control system 100 may provide the required amount of energy, and thereby the required amount of thrust (e.g., from electric motors), to maneuver the aircraft through each interval. For example, at a first interval the PDC may source 62% of energy from the battery and the remainder from the hydrogen fuel cell and at a second interval (e.g., a second later, a few feet later), the PDC may source 68% of the energy from the battery and the remainder from the fuel cell. In this example, the second interval may include a slightly higher altitude, or energy apportionment may be adjusted to maintain an altitude.

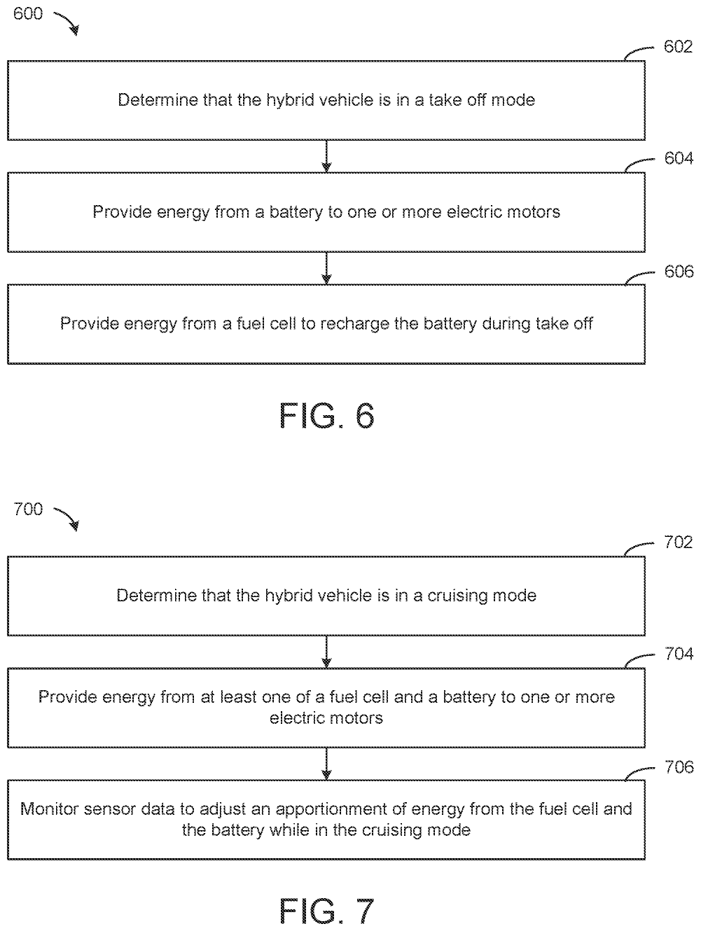

Referring now to FIG. 6, a flow diagram of a process 600 for apportioning energy during take-off of the aircraft is shown, according to some embodiments. Process 600 may be implemented by PCU 112, for example; however, it will be appreciated that in some embodiments, process 600 is implemented by other components of control system 100 or by other computing devices. It will also be appreciated that certain steps of process 600 may be optional and, in some embodiments, process 600 may be implemented using less than all of the steps.

At step 602, a determination (e.g., by the PCU 112) is made that a hybrid vehicle (e.g., an aircraft) is in a take-off mode. The take-off mode may indicate that the aircraft will be ascending to a cruising altitude, thus the aircraft will require a relatively larger amount of energy to generate lift as compared to during a cruising mode of operation. In some embodiments, this determination is made based on a user input. For example, the user may select a “take-off mode” from a user interface to autonomously or semi-autonomously control the aircraft throughout take-off. In some embodiments, it is automatically determined that the aircraft is taking off based on user input, such as via a joystick or throttle. For example, a large increase in throttle may indicate that the aircraft is required to take-off. In some embodiments, large increases in altitude may determine that the aircraft is taking off (e.g., by comparing altitude at a first time step to altitude at a second, previous time step). In some embodiments, such as during autonomous flight, an interval along a flight path may be associated with a particular operating mode.

At step 604, energy is provided from a battery to one or more electric motors (via a command from the PCU 112 to the PDC). As described above, a battery may be better suited to providing energy for take-off than a hydrogen fuel cell. Thus, during take-off, a majority of energy is provided from a battery (e.g., greater than 50% of the total required amount of energy). Accordingly, at step 606, energy may be provided from a hydrogen fuel cell to recharge the battery during take-off. In this manner, the hydrogen fuel cell may still contribute to the energy requirements for the aircraft without providing energy directly to the electric motors. Additionally, recharging the battery during take-off ensures that the battery maintains and adequate SoC for landing or other maneuvers, such as climbing.

Referring now to FIG. 7, a flow diagram of a process 700 for apportioning energy while cruising is shown, according to some embodiments. Process 700 may be implemented by PCU 112, for example; however, it will be appreciated that in some embodiments, process 700 is implemented by other components of control system 100 or by other computing devices. It will also be appreciated that certain steps of process 700 may be optional and, in some embodiments, process 700 may be implemented using less than all of the steps.

At step 702, a determination (e.g., by the PCU 112) is made that a hybrid vehicle (e.g., an aircraft) is in a cruising mode. The cruising mode may indicate that the aircraft will be or is maintaining a relatively stable altitude and/or speed, thus the aircraft will not necessarily require a large amount of energy to generate lift; however, the aircraft may require sustained energy for a longer period of time. In some embodiments, this determination is made based on a user input. For example, the user may select a “cruising mode” from a user interface to autonomously or semi-autonomously control the aircraft while cruising. In some embodiments, it is automatically determined that the aircraft is cruising based on user input, such as via a joystick or throttle. For example, a minimal increases/decreases in throttle may indicate that the aircraft is cruising. In some embodiments, altitude data is also used to determine that the aircraft is cruising. For example, relatively stable altitude measurements may indicate a cruising mode. In some embodiments, such as during autonomous flight, an interval along a flight path may be associated with a particular operating mode.

At step 704, energy is provided from a hydrogen fuel cell to one or more electric motors (e.g., by a command from the PCU 112 to the PDC). As described above, a hydrogen fuel cell may be better suited to providing energy for cruising than a battery. Thus, during cruising, a majority of energy is provided from the hydrogen fuel cell (e.g., greater than 50% and even upwards of 80%) and battery energy is reserved for a subsequent landing procedure.

At step 706, sensor data is monitored by the PCU 112 to adjust the apportionment of energy during flight. For example, altitude data may be monitored to determine whether the aircraft is gaining or losing altitude, which may indicate whether the electric motors must spinning more quickly or slowly to compensate (e.g., to maintain altitude). As another example, air speed data may be monitored to predict energy requirements and to adjust energy apportionment. Based on the sensor data, the amount of energy sourced from either the battery or the hydrogen fuel cell may be increased or decreased by the PCU 112 via the PDC 106 to maintain altitude or to respond to user inputs.

Referring now to FIG. 8, an example user interface 800 for a hybrid aircraft is shown, according to some embodiments. User interface 800 may be generated and presented by the PCU 112 via a screen in a cockpit of the hybrid aircraft, for example, or may presented via a remote display (e.g., on a computer screen). In any case, user interface 800 may provide a variety of data for controlling flight of the aircraft and for monitoring energy consumption. In some embodiments, such as with drone aircraft, the user interface 800 may be presented via a remote computing device relative to the drone aircraft (e.g., a remote operator's computer screen). In particular, user interface 800 may include a battery level indicator 802 for presenting an amount of remaining battery energy (e.g., based on SoC), and a fuel cell level indicator 804 for presenting an amount of remaining fuel cell energy (e.g., based on remaining hydrogen and/or oxygen). In this example, battery level indicator 802 and fuel cell level indicator 804 are shown as including a number of cells that, when filled in, indicate a corresponding energy level. For example, the battery is shown at approximately 60% remaining energy and the fuel cell is shown at approximately 80% remaining energy. However, it will be appreciated that any other graphic may be used to indicate battery/fuel cell levels (e.g., a percentage of maximum capacity).

User interface 800 is also shown to include graphical elements 806 and 808 for presenting operating data such as throttle level (e.g., expressed as a percentage) and RPM data. Throttle level and motor RPM may be determine based on sensor data, for example. In some embodiments, user interface 800 may also include an indication of a current operating mode which indicates an operating mode for the aircraft. As shown, for example, the example aircraft is in a battery only mode because the aircraft is either taking off, landing, or is not flying (e.g., is parked).

In some embodiments, user interface 800 also includes a map 810 which may be a map of the area currently occupied by the aircraft. For example, the aircraft's current location may be determined and displayed on map 810. In some embodiments, map 810 may also indicate a flight path for the aircraft, and may indicate stops along the flight path. It will be appreciated that map 810 may also present any other relevant flight data, such as weather data, flight time, estimated arrival time, estimated energy levels upon arrival, etc. In some embodiments, a user may be able to set or modify a flight path by selecting a “Set Route” button 812. In some such embodiments, selecting button 812 may cause a second interface (e.g., a pop-up) to be presented over user interface 800, allowing the user to input a new destination, change a point or portion of the flight path, cancel navigation to a destination, etc.

In some embodiments, a user may also manually override autonomous or semi-autonomous navigation via a “Manual Override” button 814. For example, selecting button 814 may suspend navigation to a destination and allow the user to fly manually (e.g., due to inclement weather). In some embodiments, button 814 also/alternatively allows the user to override energy apportionment. For example, the user may choose to operate mainly or entirely on battery power even when cruising. In some embodiments, the user may be presented with an alert or warning upon overriding energy apportionment. For example, an alert may be displayed that cautions the user that overriding the optimized energy apportionment may result in decreased performance and/or may cause the aircraft to run out of energy before reaching the destination. It will be appreciated that user interface 800 may also include any other graphical elements that may aid a user in operating the hybrid aircraft.

### Configuration of Exemplary Embodiments

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for providing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure may be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure. In this regard, any element disclosed in one embodiment may be incorporated or utilized with any other embodiment disclosed herein.

What is claimed is:

1. A power distribution controller for a hybrid aircraft, the controller comprising:
one or more processors; and
memory having instructions stored thereon that, when executed by the one or more processors, cause the controller to continuously:
obtain a state-of-charge (SoC) measurement for a battery of the hybrid aircraft;
obtain a fuel level measurement for a secondary energy source of the hybrid aircraft;
receive a control input indicating one of a throttle level or an operating mode for one or more motors of the hybrid aircraft;
calculate a ratio of energy to source from each of the battery and the secondary energy source in order to operate the one or more motors of the hybrid aircraft based on the control input, the SoC measurement, and the fuel level measurement; and
transmit a control signal that causes energy to be apportioned from the battery and the secondary energy source to the one or more motors based on the determined ratio.

2. The controller of claim 1, wherein the instructions cause the controller to further:
determine an operating mode for the hybrid aircraft based on the control input, wherein the operating mode is one of a take-off mode, a landing mode, or a cruising mode;
wherein:
in the take-off mode or the landing mode, more than 50% of the energy to operate the one or more motors of the hybrid aircraft is sourced from the battery; or
in the cruising mode, more than 50% of the energy to operate the one or more motors of the hybrid aircraft is sourced from the secondary energy source.

3. The controller of claim 1, wherein, if the ratio indicates that a greater portion of energy is sourced from the secondary energy source than the battery, the controller is further configured to transmit a second control signal that causes the second energy source to recharge the battery.

4. The controller of claim 1, wherein the secondary power source is a hydrogen fuel cell.

5. The controller of claim 1, wherein the one or more motors are electric motors.

6. The controller of claim 1, wherein the hybrid aircraft is a helicopter, a vertical take-off and landing (VTOL) aircraft, or an electrical vertical take-off and landing (eVTOL) aircraft.

7. The controller of claim 1, wherein the fuel level measurement comprises a measurement of a fill level of each of an oxygen tank and a hydrogen tank.

8. The controller of claim 7, wherein the instructions cause the controller to further calculate an amount of electrical energy that can be provided by the secondary power source based on the fill level of each of the oxygen tank and the hydrogen tank.

9. The controller of claim 1, wherein the instructions cause the controller to:
receive additional data from at least one of an altitude sensor, an air speed sensor, or sensors that measure a rotational speed of each of the one or more motors of the hybrid aircraft; and
adjust the ratio based on the additional data.

10. The controller of claim 1, wherein the instructions cause the controller to generate a graphical user interface that indicates, in real-time, the SoC measurement, the fuel level measurement, and the ratio.

11. A method for distributing power to electric motors on a hybrid aircraft, the method comprising:
obtaining a state-of-charge (SoC) measurement for a battery of the hybrid aircraft;
obtaining a fuel level measurement for a secondary power source of the hybrid aircraft;
receiving a control input indicating one of a throttle level or an operating mode for the electric motors of the hybrid aircraft;
calculating a ratio of energy to source from each of the battery and the secondary power source in order to operate the electric motors of the hybrid aircraft based on the control input, the SoC measurement, and the fuel level measurement; and
transmitting a control signal that causes energy to be apportioned from the battery and the secondary power source to the electric motors based on the determined ratio.

12. The method of claim 9, further comprising:
determining an operating mode for the hybrid aircraft based on the control input, wherein the operating mode is one of a take-off mode, a landing mode, or a cruising mode, wherein:
in the take-off mode or the landing mode, more than 50% of the energy to operate the one or more motors of the hybrid aircraft is sourced from the battery; or
in the cruising mode, more than 50% of the energy to operate the one or more motors of the hybrid aircraft is sourced from the secondary energy source.

13. The method of claim 9, further including transmitting a second control signal that causes the second energy source to recharge the battery responsive to a determination that a greater portion of energy is sourced from the secondary energy source than the battery.

14. The method of claim 9, wherein the secondary power source is a hydrogen fuel cell.

15. The method of claim 9, wherein the hybrid aircraft is a helicopter, a vertical take-off and landing (VTOL) aircraft, or an electrical vertical take-off and landing (eVTOL) aircraft.

16. The method of claim 9, wherein the fuel level measurement comprises a measurement of a fill level of each of an oxygen tank and a hydrogen tank.

17. The method of claim 16, further comprising calculating an amount of electrical energy that can be provided by the secondary power source based on the fill level of each of the oxygen tank and the hydrogen tank.

18. The method of claim 9, further comprising:
receiving additional data from at least one of an altitude sensor, an air speed sensor, or sensors that measure a rotational speed of each of the one or more motors of the hybrid aircraft; and
adjusting the ratio based on the additional data.

19. The method of claim 9, further comprising generating a graphical user interface that indicates, in real-time, the SoC measurement, the fuel level measurement, and the ratio.

20. A system for apportioning energy from multiple sources in a hybrid aircraft, the system comprising:
a power control unit configured to:
determine a state-of-charge (SoC) measurement for a battery of the hybrid aircraft and a fuel level measurement for a hydrogen fuel cell of the hybrid aircraft;
receive a control input indicating one of a throttle level or an operating mode for one or more motors of the hybrid aircraft; and
calculate a ratio of energy to source from each of the battery and the secondary energy source in order to operate the one or more motors of the hybrid aircraft based on the control input, the SoC measurement, and the fuel level measurement; and
a power distribution center in communication with the power control unit, the power distribution center configured to:
apportion energy from the battery and the secondary energy source to the one or more motors based on the ratio determined by the power control unit.
